(19) United States
(12) Patent Application Publication
(10) Pub. No.: US 2024/0413721 A1
(43) Pub. Date: Dec. 12, 2024

(54) METHOD FOR PRODUCING AN ELECTRIC MACHINE

(71) Applicant: ZF FRIEDRICHSHAFEN AG, Friedrichshafen (DE)

(72) Inventors: Konrad BUETTNER, Gädheim (DE); Matthias CUDOK, Ritschenhausen (DE); Ignacio LOBO CASANOVA, Markdorf (DE); Michael ZÖLLER, Oberpleichfeld (DE)

(21) Appl. No.: 18/702,967

(22) PCT Filed: Oct. 20, 2022
(86) PCT No.: PCT/EP2022/079251

§ 371 Date: Apr. 19, 2024

(30) Foreign Application Priority Data
Oct. 22, 2021 (DE) 10 2021 211 921.2

(51) Int. Cl. H02K 15/12; H02K 1/20; H02K 3/34

(52) U.S. Cl. CPC H02K 15/12; H02K 1/20; H02K 3/345

(57) ABSTRACT

A method for producing an electric machine, in particular an electric machine for a motor vehicle, having a can that delimits a rotor chamber of the electric machine from a stator chamber of the electric machine. The method provides for introducing a stator main part into a molding tool having at least one element for keeping an area free, the element engaging into a stator groove of the stator main part when the stator main part is received in the molding tool and defining a receiving region for at least one conductor in the stator groove; introducing a main part, in particular a tubular main part, into an opening of the stator main part; injecting a curable resin material; hardening the resin material; and removing the stator main part from the molding tool.

### CROSS REFERENCE TO RELATED APPLICATIONS

This is a U.S. national stage of Application No. PCT/EP2022/079251 filed Oct. 20, 2022.Priority is claimed on German Application No. DE 10 2021 211 921.2 filed Oct. 22, 2021, the content of which is incorporated herein by reference.

### BACKGROUND OF THE INVENTION

### 1. Field of the Invention

The disclosure relates to a method for producing an electric machine, in particular an electric machine for a motor vehicle, comprising a can that delimits a rotor chamber of the electric machine from a stator chamber of the electric machine.

### 2. Description of the Related Art

Electric machines for motor vehicles and methods for producing them are known in principle from the prior art, for example from DE 10 2017 213 662 A1, DE 10 2017 112 365 A1 or from US 2019 229 566 A1. Such electric machines have a stator, which can be divided into a stator chamber and a rotor chamber. The stator slots, in which the individual conductors, also known as “hairpins”, are housed, are located in the stator chamber, while the rotor is arranged in the rotor chamber. A so-called air gap is formed between the rotor and the stator, for example the tooth heads of the stator slots and the rotor rotating or rotatably mounted in the rotor chamber. A can is used to separate the rotor chamber from the stator chamber, for example to insulate the rotor chamber from the stator chamber. The can therefore lies on an inside of the stator chamber and separates the rotor chamber from the stator chamber in the radial direction so that there is no connection between the stator slots and the rotor chamber.

It is known that the can is usually manufactured as a separate component and must be inserted into the stator at great expense, for example the can is pressed into the stator. Various processes are known for producing the can, for example a wet winding process, which requires long curing times on the one hand and costly additional materials, in particular so-called “shrink tapes”, on the other. As the can must be subsequently pressed into the opening of the stator, tight tolerances must be maintained, which can often only be achieved using complex machining processes. High forces are also required for the press-fitting process, which limits the design of comparatively thin cans. When the can is inserted or pressed in, abrasion may also occur, which must be removed.

### SUMMARY OF THE INVENTION

An object of one aspect of the invention is to provide an improved method for producing an electric machine for a motor vehicle.

As described, one aspect of the invention relates to a method for producing an electric machine comprising a can that separates a rotor chamber of the electric machine from a stator chamber of the electric machine. The method for producing the electric machine can ultimately also be understood as a production method for a semi-finished product, in which a stator is obtained as a semi-finished product together with the can. This semi-finished product, i.e., the stator provided with the can, can then be produced by joining further components to form the electric machine. All the features described herein, which are described in the context of methods for producing the electric machine, can therefore also be transferred to a method for producing such a stator.

The method comprises the following steps:
introducing a stator main part into a molding tool, wherein the molding tool has at least one element for keeping an area free, which element, when the stator main part is received in the molding tool, engages in a stator slot of the stator main part and defines a receiving region for at least one conductor in the stator slot;
introducing a main part, in particular a tubular main part, into an opening of the stator main part;
injecting a curable resin material;
curing the resin material; and
removing the stator main part from the molding tool.

One aspect of the invention is based on the finding that a stator main part is introduced into a molding tool, which molding tool has elements or at least one element for keeping an area free, which element defines a receiving region for at least one conductor in the stator slot.

The element for keeping an area free or the plurality of elements for keeping an area free engages in the respective stator slots of the stator main part. In other words, the elements for keeping an area free are elongate, pin-like elements, which are components of the molding tool and which engage in the stator slots when the stator main part is introduced into the molding tool. In particular, the molding tool has exactly as many elements for keeping an area free as the stator main part has stator slots. In other words, an element for keeping an area free is received in each stator slot so that the stator slots are kept free by the element for keeping an area free. The elements for keeping an area free thus act as “placeholders” for the conductors, such as hairpins, which are to be inserted into the receiving regions in a subsequent production process.

Furthermore, the method involves introducing a main part, in particular a tubular main part, into an opening of the stator main part. The opening of the stator main part defines the rotor chamber. The main part thus forms the main body for the can, which is produced in the production process. Instead of manufacturing the can separately, taking into account the tight tolerances, and then introducing it into the opening of the stator main part at great expense, in particular by a complex press-fitting process, one aspect of the invention proposes using the main part and introducing it into the stator main part. In particular, the main part can be a fiber main part, for example a tube made of fiber materials, which is applied to a core, for example a cylinder. The main part can either be introduced into the molding tool together with the stator main part or, alternatively, can be introduced into the opening of the stator main part after the stator main part has been introduced into the molding tool. In particular, the main part can be impregnated with the curable resin material or has a structure which is designed to receive the resin material so that it is bonded to the main part after curing.

In a further process step, the molding tool is filled with curable resin material. In particular, curable resin material can be injected into the molding tool. The curable resin material can then be cured so that the stator main part or the (semi-finished) stator can then be removed from the molding tool. When the resin material is injected, the main part is impregnated so that the can is formed from the main part and the resin material. In addition, the resin material penetrates into the area around the elements for keeping an area free so that the stator slots can be filled with the resin material except for the elements for keeping an area free. If the stator main part is removed from the molding tool after the resin material has cured, the elements for keeping an area free are pulled out of the receiving regions so that the receiving regions are ultimately kept free to receive conductors. The injection process can be used to connect the can to the slot insulations in the stator slots, which enclose the receiving regions, so that the can is simultaneously secured in the stator slots or the can is anchored in the stator slots.

Advantageously, this eliminates the need for a separate production process in which a can is elaborately produced and then just as elaborately introduced into the stator main part. Instead, the can may be produced directly in the stator main part. This eliminates the need for complex fitting or press-fitting processes.

It is thus possible for the can of the electric machine to be produced by the cured resin material and the main part, in particular in one piece with the slot insulations received in the stator slots, which form the receiving regions or insulate receiving regions with respect to the stator slot. In other words, by injecting and curing the resin material in the stator slots, slot insulations are formed that surround the elements for keeping an area free. As a result, the slot insulations surround the receiving regions, which are defined by the elements for keeping an area free. The production process of the can and the rest of the stator can therefore be described or considered as a “one-shot process”, as both the receiving regions, the slot insulations and the can are produced in the same production process in the stator main part itself. A one-part design of the slot insulations in the stator slots with the can is suitable here, as these can be filled, in particular by injecting the same resin material, and then cured. The one-part design forms a particularly robust and stable construction and, as described above, anchors the can in the stator slots. As the can is produced inside the stator main part, the tolerances of the can do not have to be adjusted subsequently, but are automatically formed to fit the inner circumference of the stator main part precisely due to the injection process.

According to a further aspect of the method, the slot insulations in the stator slots can be produced over the entire surface and can insulate the interior spaces of the receiving regions from the interior surfaces of the stator slots. As described, the curable resin material is also injected into the stator slots in which the elements for keeping an area free are received during the production of the can. The elements for keeping an area free are correspondingly smaller than the stator slots and therefore do not fill them, accordingly. In particular, a volume remains free around the elements for keeping an area free and can be filled by the resin material and thus forms the slot insulations. According to this aspect, the resin material should surround the entire surface of the elements for keeping an area free so that the entire stator slots around the elements for keeping an area free are filled with resin material.

Curing the completely filled stator slots allows the inner surfaces of the stator slots to be completely insulated. After removal of the stator main part from the molding tool, during which the elements for keeping an area free are removed from the stator slots, the elements for keeping an area free release the receiving regions into which the conductors can then be inserted. The receiving regions for the conductors are thus kept free by the elements for keeping an area free, wherein on the one hand the conductors are correctly positioned in the receiving regions by the slot insulations and on the other hand are also insulated with respect to the stator slots. A stator produced in this way therefore has, in the stator slots, slot insulations surrounding receiving regions, which completely seal and insulate the receiving regions from the inner surfaces of the stator slots. A conductor held in the receiving region therefore has no electrical contact with the stator slots, but lies against the inside of the slot insulation arranged in the stator slot.

The method can also be further developed in such a way that at least one slot insulation is produced with a temperature-control channel region, in particular a radially inner temperature-control channel region. The temperature-control channel region can define a region in which, similarly to the receiving regions, a volume is kept free in order to form a temperature-control channel after removal of the stator main part from the molding tool. A stator main part produced in this way therefore has a temperature-control channel region, which can be located radially on the inside in particular. Temperature-control medium can then be fed through the temperature-control channel region in order to control the temperature of the stator main part. In particular, coolant can be used here to dissipate heat from the stator main part and cool the electric machine.

The method may also provide for at least one slot insulation to be produced with an anti-rotation device. The anti-rotation device has the particular effect of preventing rotation between the can or the slot insulations produced from curable resin material and the stator main part. As described, the stator main part is filled with curable resin material, wherein the main part is also impregnated with curable resin material. The curable resin material injected into the stator slots and the curable resin material of the main part can bond here completely, in particular, so that the can is subsequently prevented from twisting.

According to a further aspect of the method, it can be provided that at least one parameter, in particular a main part geometry and/or a main part material, of the main part is selected or set differently in at least two regions, in particular in two axial regions. As described, the main part can, for example, be designed in the form of a tube or hose. In particular, the main part is made of fiber material, which can be woven or braided, for example. At least one parameter of the main part can be selected differently in at least two regions. For example, a first axial region can be connected to a second axial region, wherein the at least one parameter is selected differently in the first axial region than in the second axial region. One or more parameters relating to a main part geometry and/or a main part material can be selected as the parameter.

In particular, a fiber orientation, a diameter of the main part, a material, in particular a fiber material, for example carbon fibers or glass fibers, can be used as parameters. Any combinations of individual parameters are possible to form parameter groups, which can be selected in the different regions of the main part. It is also possible here to set the diameter of the main part differently in different axial regions. For example, the diameter of the main part can vary, for example in the form of a conical transition in the axial direction.

The described molding tool can be heated at least in portions and/or at least temporarily. Depending on which curable resin material is used and which curing process is used in the production of the electric machine, the molding tool can be heated in a targeted manner, in particular to accelerate the curing process. The molding tool can, for example, consist of two halves or comprise at least two halves. The molding tool can be closed before the curable resin material is injected. After injecting the curable resin material or before, the molding tool can be heated. Different regions of the mold can be heated here to different temperatures. It is also possible to run through different temperature profiles. For example, different temperatures can be defined for different process steps. It is also possible to heat different parts of the stator main part within the molding tool to different temperatures.

The core described above, which carries the fiber base material or the main part and on the outer circumference of which the main part is arranged, can be variable in volume according to one embodiment of the method. In other words, a variable-volume core can be used in the method described. The core can thus have a different volume in at least two process steps.

For example, the volume of the core can be reduced in order to demold or remove the stator main part from the molding tool. The core can be retractable or inflatable for this purpose so that its volume can be adapted to the desired size of the main part.

One aspect of the invention also relates to a stator for an electric machine for a motor vehicle, comprising a can that delimits a rotor chamber from a stator chamber, wherein the can is designed in one part with a slot insulation. Accordingly, the stator can have a can which is connected, in particular by a common injection process, to slot insulations received in the stator slots.

The slot insulations can be formed over the entire surface of the stator slots and insulate the interior spaces of the receiving regions with respect to the inner surfaces of the stator slots. As a result, conductors introduced into the receiving regions can be positioned and, at the same time, the slot insulation insulates the conductors from the stator main part.

In the stator, it can also be provided that at least one receiving region or slot insulation has at least one temperature-control channel region, in particular a radially inner temperature-control channel region. The previously described elements for keeping an area free can have corresponding regions that keep the temperature-control channel regions free during the injection process so that these are also formed in the slot insulation. The stator can also have at least one slot insulation with an anti-rotation device. The anti-rotation device ensures that the can cannot rotate within the stator opening and is secured within the stator slots.

One aspect of the invention also relates to a device for producing an electric machine, which device is designed to carry out the method described above. The device thus has, in particular, the components required for carrying out the method. For example, the device comprises the molding tool, which can in particular comprise two tool halves or a plurality of tool parts, which can be opened or closed to produce the electric machine. Furthermore, the device has, for example, an injection mechanism designed to inject curable resin material into the molding tool. The device may further comprise a temperature controller designed to provide controlled heating of the molding tool section by section and/or temporarily. One aspect of the invention further relates to an electric machine with a stator as described above. One aspect of the invention also relates to a motor vehicle comprising an electric machine produced according to the method described above. An electric machine produced in this way thus has, in particular, a can which is connected to slot insulations connected in the stator slots, in particular consists in one part of the same curable or cured resin material or comprises such a material.

All of the advantages, details and features described in relation to the method are fully transferable to the device, the stator, the electric machine and the motor vehicle.

### BRIEF DESCRIPTION OF THE DRAWINGS

Aspects of the invention are explained below with reference to the figures on the basis of exemplary embodiments. The figures are schematic representations, in which:

FIG. 1 is a device for producing an electric machine;

FIG. 2 is a detail of the device in FIG. 1;

FIG. 3 is a detail of an electric machine; and

FIG. 4 is a main part.

### DETAILED DESCRIPTION OF THE PRESENTLY PREFERRED EMBODIMENTS

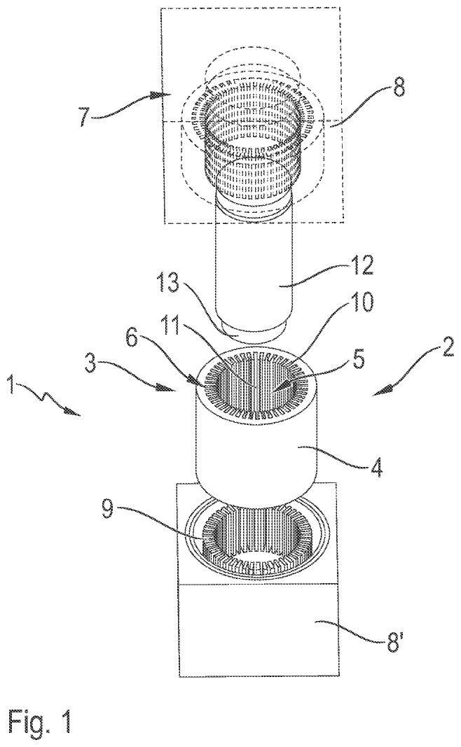

FIG. 1 schematically shows a device 1 for producing an electric machine 2, in particular for producing a stator 3. The stator 3 comprises, among other things, a stator main part 4, which has a rotor chamber 5 and a stator chamber 6. The device 1 shown has a molding tool 7, which comprises two tool halves 8, 8′ by way of example only. The molding tool 7 can comprise further parts and components and does not have to consist of the tool halves 8, 8′, as shown. The molding tool 7 has elements 9 for keeping an area free, which, in a received state, in which the stator main part 4 is received in the molding tool 7, engage in stator slots 10 in the stator chamber 6 of the stator 3.

As shown in FIG. 1, a main part 12, which is arranged on a core 13, is inserted into a stator opening 11 of the stator main part 4. The main part 12 is made, in particular, from a woven or braided fiber material and is mounted on the core 13. The main part 12 and the core 13 can thus be inserted into the stator opening 11. The two tool halves 8, 8′ can then be closed. A curable resin material can then be injected into the molding tool 7 via an injection mechanism, not shown in detail. The main part 12 is impregnated here with the curable resin material. Furthermore, the curable resin material is also injected into the gaps between the elements 9 for keeping an area free and the stator slots 10. The curable resin material can then be cured, in particular by controlled heating of the molding tool 7 at least temporarily and/or in sections.

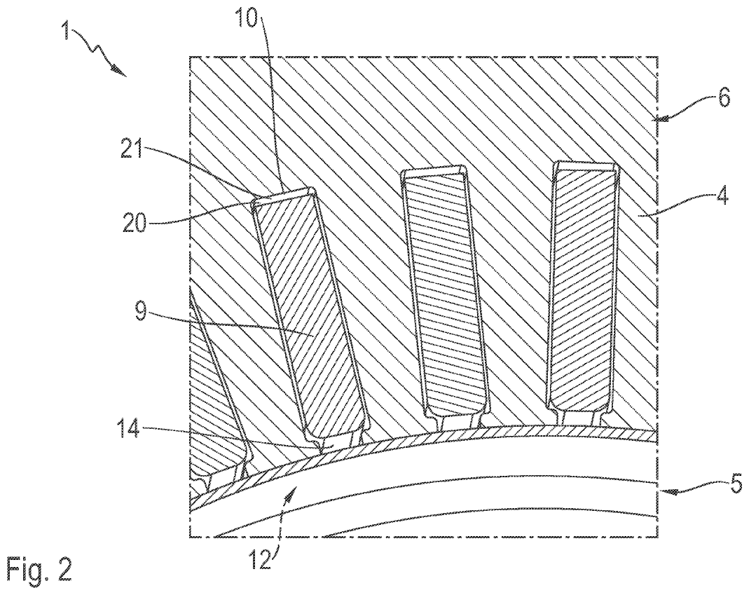

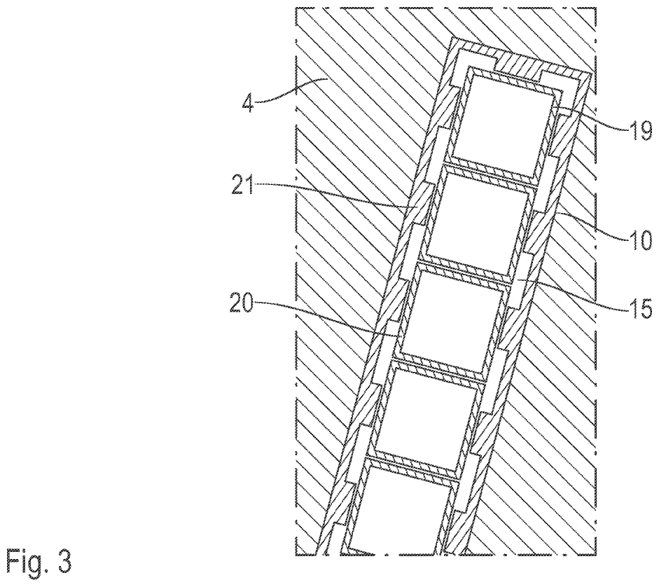

FIG. 2 shows a detail of the stator main part 4 in the molding tool 7. It can be seen that the elements 9 for keeping an area free engage in the stator slots 10 of the stator main part 4. The main part 12 rests against an inner circumference of the laminated core of the stator main part 4, i.e., at a transition between the stator chamber 6 and the rotor chamber 5. As described, the main part 12 is arranged on the core 13 and is thus carried or supported by the core 13 on its inner circumference. Once the stator main part 4 has been demolded or removed from the molding tool 7, the element 9 for keeping an area free keeps receiving regions 20 free. Conductors 19 of the electric machine 2 can be inserted into these receiving regions 20. In particular, a full-surface lining of the stator slots 10 by the curable resin material can be provided so that the conductors 19 are completely insulated from the inner circumference of the stator slots 10 by slot insulations 21 (cf. FIG. 3). The slot insulations 21 are thus formed by the resin material, which flows into the stator slots 10 and cures around the elements 9 for keeping an area free.

Furthermore, it is possible to introduce an anti-rotation device 14, via which the main part 12, which forms the can when cured, is connected to the slot insulations 21. Since the curable resin material or the cured resin material thus forms the can on the one hand and engages in the stator slots 10 on the other, twisting of the can relative to the stator chamber 6 or the rotor chamber 5 is prevented. Such an anti-rotation device 14 can be implemented in each stator slot 10 or in selected stator slots 10, for example in two stator slots 10 spaced at 180°, four stator slots 10 spaced at 90°, or six stator slots 10 spaced at 60°, and the like.

As described, the stator main part 4 can be removed from the molding tool 7 after the curable resin material has cured. It is also possible to remove the core 13 after the curable resin material has cured. The core 13 can be variable in volume for this purpose. For example, the core 13 can be designed to be retractable or inflatable in order to adjust its volume in such a way that the desired volume is formed for the main part 12.

FIG. 3 also shows that the elements 9 for keeping an area free can have any geometries. For example, the elements 9 for keeping an area free can have shapes that keep the temperature-control channel regions 15 free. After the resin material has cured and the stator main part 4 has been removed, the elements 9 for keeping an area free thus release receiving regions 20, which also have temperature-control channel regions 15 or the slot insulations 21 have temperature-control channel regions 15. If the conductors 19 are inserted into the receiving regions 20, as shown in FIG. 3, it is possible to feed temperature control medium, in particular coolant, through the temperature-control channel regions 15 through the stator slots 10 in order to control their temperature. At the same time, each of the temperature-control channel regions 15 is sealed because, as described above, the entire surface of the receiving region 20 is sealed and insulated with respect to the stator slot 10 by the slot insulation.

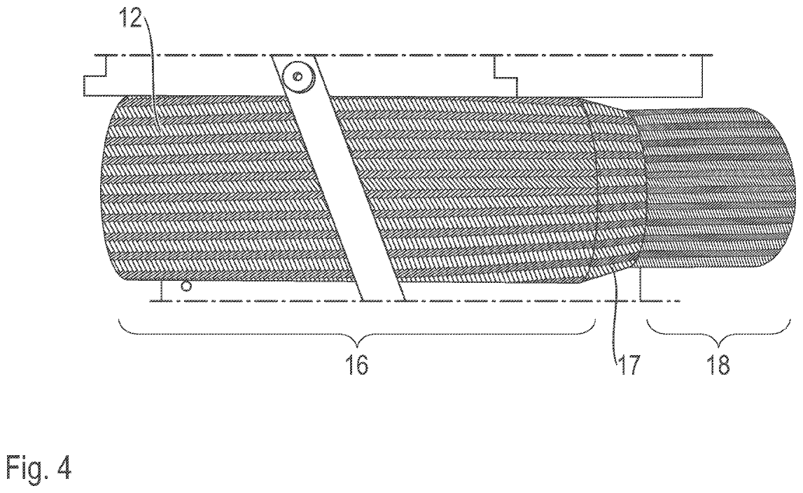

FIG. 4 shows a main part 12 by way of example only. The main part 12 has three axial regions 16-18. In this exemplary embodiment, the main part 12 can have different parameters in the various axial regions 16-18. The parameters can be selected as desired, for example from a range relating to the material of the main part 12 or the geometry of the main part 12. In particular, the alignment of the fibers or the orientation of the fibers of the main part 12 and the diameter of the main part 12 can be influenced. For example, a first diameter is realized in the axial region 16, which is larger than a second diameter in the axial region 18. In the axial region 17, for example, a conical transition is realized, which transitions, in particular linearly, from the first diameter to the second diameter and thus connects the axial region 16 to the axial region 18. Furthermore, it is possible to use different materials for the main part 12, for example fiber materials, in particular carbon fibers or glass fibers or any mixtures. The geometry of the can designed by the main part 12 can also be selected as desired. In particular, cylindrical, rectangular, polygonal or rounded profiles can be used.

The advantages, details and features shown in the individual exemplary embodiments are interchangeable, transferable and combinable with one another.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-15. (Canceled)

16. A method for producing an electric machine having a can that delimits a rotor chamber of the electric machine from a stator chamber of the electric machine, the method comprising:
introducing a stator main part into a molding tool, wherein the molding tool has at least one element configured to keep an area free which, when the stator main part is received in the molding tool, engages in a stator slot of the stator main part and defines a receiving region for at least one conductor in the stator slot;
introducing a main part into an opening in the stator main part;
injecting a curable resin material;
curing the curable resin material;
removing the stator main part from the molding tool.

17. The method as claimed in claim 16, wherein the can of the electric machine is produced by the cured resin material and the main part in at least one portion has slot insulation received in the stator slot.

18. The method as claimed in claim 17, wherein the slot insulation in the stator slot is produced over an entire surface and insulates an interior space of the receiving region with respect to an inner surface of the stator slot.

19. The method as claimed in claim 17, wherein at least one receiving region or a slot insulation is produced with at least one temperature-control channel region configured as a radially inner temperature-control channel region.

20. The method as claimed in claim 17, wherein at least one slot insulation is produced with an anti-rotation device.

21. The method as claimed in claim 16, wherein at least one of a main part geometry of the main part and/or a material of the main part is selected or set differently in at least two axial regions.

22. The method as claimed in claim 16, wherein the molding tool is heated at least in sections and/or at least temporarily.

23. The method as claimed in claim 16, wherein a variable-volume core is used.

24. A device for producing an electric machine, comprising:
a molding tool, wherein the molding tool has at least one element configured to keep an area free which, when a stator main part is received in the molding tool, engages in a stator slot of the stator main part and defines a receiving region for at least one conductor in the stator slot.

25. A stator for an electric machine for a motor vehicle, comprising:
a can that delimits a rotor chamber from a stator chamber,
wherein the can is designed in one part with a slot insulation.

26. The stator as claimed in claim 25, wherein the slot insulation in a stator slot is formed over an entire surface and insulates an interior space of a receiving region with respect to inner surfaces of the stator slot.

27. The stator as claimed in claim 26, wherein at least one receiving region or the slot insulation has at least one temperature-control channel region, configured as a radially inner temperature-control channel region.

28. The stator as claimed in claim 25, wherein at least one slot insulation has an anti-rotation device.

29. An electric machine with a stator comprising:
a rotor chamber;
a stator chamber; and
a can that delimits the rotor chamber from the stator chamber,
wherein the can is designed in one part with a slot insulation.

30. A motor vehicle comprising:
an electric machine comprising:
a can that delimits a rotor chamber from a stator chamber,
wherein the can is designed in one part with a slot insulation.

31. The method as claimed in claim 16, wherein the electric machine is an electric machine for a motor vehicle.

32. The method as claimed in claim 16, wherein the main part is a tubular main part.
